(19) United States
(12) Patent Application Publication
(10) Pub. No.: US 2025/0094371 A1
(43) Pub. Date: Mar. 20, 2025

(54) PROCESSING SYSTEM, PROCESSING APPARATUS, PROCESSING METHOD AND PROGRAM

(71) Applicant: Nippon Telegraph and Telephone Corporation, Tokyo (JP)

(72) Inventors: Kiwami INOUE, Musashino-shi, Tokyo (JP); Junki ICHIKAWA, Musashino-shi, Tokyo (JP); Yukio TSUKISHIMA, Musashino-shi, Tokyo (JP); Kenji SHIMIZU, Musashino-shi, Tokyo (JP); Hideki NISHIZAWA, Musashino-shi, Tokyo (JP)

(21) Appl. No.: 18/726,624

(22) PCT Filed: Jan. 12, 2022
(86) PCT No.: PCT/JP2022/000663

§ 371 Date: Jul. 3, 2024

(51) Int. Cl. G06F 13/28

(52) U.S. Cl. CPC G06F 13/28

(57) ABSTRACT

A local terminal transmits to a processing device an RDMA transmission packet in which processing data to be transferred to a memory of an accelerator of each of a first remote terminal and a second remote terminal is set. The processing device acquires a QPN from the first remote terminal, converts a Destination QP of a BTH of the RDMA transmission packet into the QPN acquired from the first remote terminal, and transmits a converted RDMA transmission packet to the first remote terminal. When a connection is established, the processing device acquires a QPN from the second remote terminal, converts the Destination QP of the BTH of the RDMA transmission packet into the QPN acquired from the second remote terminal, and transmits a converted RDMA transmission packet to the second remote terminal. Each of the first and second remote terminal transfers the processing data to the memory of the accelerator.

### TECHNICAL FIELD

The present invention relates to a processing system, processing device, a processing method, and a program.

### BACKGROUND ART

In recent years, a communication scheme for distributing the same data to a large number of terminals, such as streaming distribution, a video conference, and an online game, has become widespread as content has become higher in quality. In such a communication scheme, it is necessary to perform from reception of large-capacity data to arithmetic processing at high speed and with low delay.

There is a communication scheme of directly transferring data to the memory of an accelerator without using a CPU. The accelerator is hardware specialized for a specific arithmetic operation, such as a graphics processing unit (GPU) or a tensor processing unit (TPU). This communication scheme directly connects a network and computing, and realizes high-speed and low-delay data reception and arithmetic operation.

As a protocol capable of directly transferring data to the memory of an accelerator, RDMA is known (Non Patent Literature 1). In a SEND operation scheme of an RDMA protocol, a local terminal and a remote terminal are connected by Peer to Peer (P2P) in a service type of Reliable Connection (RC), and high-speed inter-memory communication is enabled. The local terminal creates a send queue (SQ) of the remote terminal as a transmission destination of the SEND operation, and performs data transfer without passing through the operating systems of the both computers.

### CITATION LIST

### Non Patent Literature

Non Patent Literature 1: InfiniBand Architecture Specification Volume 1 Release 1.4, Apr. 7, 2020.

### SUMMARY OF INVENTION

### Technical Problem

However, in a case where inter-memory communication is performed from a local terminal to a plurality of remote terminals by using RDMA, the local terminal may be overloaded. Since the local terminal creates an SQ for each of the remote terminals, a processing load is generated in the local terminal. In addition, since the SQ is transmitted from the local terminal to each of the remote terminals, a transmission flow rate in the local terminal becomes enormous.

The present invention has been made in view of the above circumstances, and an object of the present invention is to provide a technique capable of reducing the load on a local terminal that transfers data to a plurality of remote terminals.

### Solution to Problem

A processing system according to one aspect of the present invention includes a local terminal, a first remote terminal, a second remote terminal, and a processing device. The local terminal transmits to the processing device an RDMA transmission packet in which processing data to be transferred to a memory of an accelerator of each of the first remote terminal and the second remote terminal is set. The processing device includes a local-side control unit that establishes a connection with the local terminal and receives the RDMA transmission packet from the local terminal, a first remote-side control unit that establishes a connection with the first remote terminal, a second remote-side control unit that establishes a connection with the second remote terminal, and a duplication unit that inputs the RDMA transmission packet to the first remote-side control unit and the second remote-side control unit. The first remote-side control unit acquires a QPN from the first remote terminal when a connection is established, converts a Destination QP of a Base Transport Header (BTH) of the RDMA transmission packet into the QPN acquired from the first remote terminal, and transmits a converted RDMA transmission packet to the first remote terminal. The second remote-side control unit acquires a QPN from the second remote terminal when a connection is established, converts the Destination QP of the BTH of the RDMA transmission packet into the QPN acquired from the second remote terminal, and transmits a converted RDMA transmission packet to the second remote terminal. The first remote terminal receives the converted RDMA transmission packet and transfers the processing data to the memory of the accelerator. The second remote terminal receives the converted RDMA transmission packet and transfers the processing data to the memory of the accelerator.

A processing device according to one aspect of the present invention includes: a local-side control unit that establishes a connection with a local terminal and receives from the local terminal an RDMA transmission packet in which processing data to be transferred to a memory of an accelerator of each of a first remote terminal and a second remote terminal is set; a first remote-side control unit that establishes a connection with the first remote terminal; a second remote-side control unit that establishes a connection with the second remote terminal; and a duplication unit that inputs the RDMA transmission packet to the first remote-side control unit and the second remote-side control unit. The first remote-side control unit acquires a QPN from the first remote terminal when a connection is established, converts a Destination QP of a BTH of the RDMA transmission packet into the QPN acquired from the first remote terminal, and transmits a converted RDMA transmission packet to the first remote terminal. The second remote-side control unit acquires a QPN from the second remote terminal when a connection is established, converts the Destination QP of the BTH of the RDMA transmission packet into the QPN acquired from the second remote terminal, and transmits a converted RDMA transmission packet to the second remote terminal.

A processing method according to an aspect of the present invention includes: by a local terminal, transmitting to a processing device, an RDMA transmission packet in which processing data to be transferred to a memory of an accelerator of each of a first remote terminal and a second remote terminal is set; by the processing device, establishing a connection with the local terminal, and receiving the RDMA transmission packet from the local terminal; by a first remote-side control unit of the processing device, establishing a connection with the first remote terminal; by a second remote-side control unit of the processing device, establishing a connection with the second remote terminal; by the processing device, inputting the RDMA transmission packet to the first remote-side control unit and the second remote-side control unit; by the first remote-side control unit of the processing device, acquiring a QPN from the first remote terminal when a connection is established, converting a Destination QP of a base transport header (BTH) of the RDMA transmission packet into the QPN acquired from the first remote terminal, and transmitting a converted RDMA transmission packet to the first remote terminal; by the second remote-side control unit of the processing device, acquiring a QPN from the second remote terminal when a connection is established, converting the Destination QP of the BTH of the RDMA transmission packet into the QPN acquired from the second remote terminal, and transmitting a converted RDMA transmission packet to the second remote terminal; by the first remote terminal, receiving the converted RDMA transmission packet that and transferring the processing data to the memory of the accelerator; and by the second remote terminal, receiving the converted RDMA transmission packet and transferring the processing data to the memory of the accelerator.

According to one aspect of the present invention, there is provided a program for causing a computer to function as the processing device.

### Advantageous Effects of Invention

According to the present invention, it is possible to provide a technique capable of reducing the load on a local terminal that transfers data to a plurality of remote terminals.

### BRIEF DESCRIPTION OF DRAWINGS

FIG. 1 is a diagram illustrating a system configuration of a processing system according to an embodiment of the present invention.

FIG. 2 is a diagram illustrating processing of transmitting a general RDMA transmission packet by P2P.

FIG. 3 is a diagram illustrating functional blocks of a processing device according to the embodiment of the present invention.

FIG. 4 is a diagram describing examples of data structures and data of conversion tables in the processing device.

FIG. 5 is a diagram describing examples of data structures and data of history tables in the processing device.

FIG. 6 is a sequence diagram describing processing of establishing a connection in the processing system according to the embodiment of the present invention (part 1).

FIG. 7 is a sequence diagram describing a process of establishing a connection in the processing system according to the embodiment of the present invention (part 2).

FIG. 8 is a sequence diagram describing processing of transferring processing data in the processing system according to the embodiment of the present invention.

FIG. 9 is a diagram illustrating an RDMA transmission packet transmitted from a local terminal and an RDMA transmission packet transmitted to a first remote terminal.

FIG. 10 is a flowchart describing establishment processing by an establishment unit of the processing device.

FIG. 11 is a diagram describing settings in the establishment processing.

FIG. 12 is a flowchart describing conversion processing by a conversion unit of the processing device.

FIG. 13 is a diagram describing settings in the conversion processing.

FIG. 14 is a diagram describing update in the conversion processing.

FIG. 15 is a diagram illustrating a hardware configuration of a computer used in the processing device.

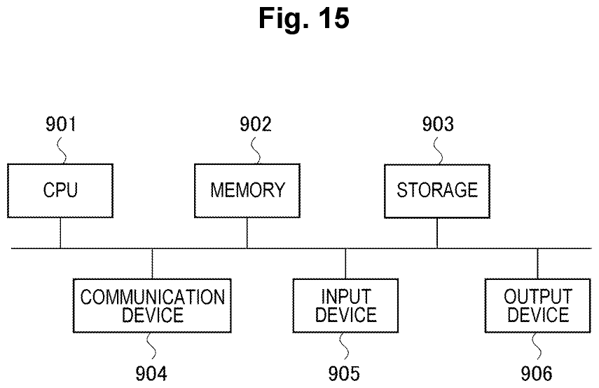

### DESCRIPTION OF EMBODIMENTS

Hereinafter, an embodiment of the present invention will be described with reference to the drawings. In the drawings, the same parts are denoted by the same reference signs, and description thereof is omitted.

In the embodiments of the present invention, the following abbreviations are used.
RDMA Remote Direct Memory Access
QP Queue Pair
SQ Send Queue
RQ Receive Queue
CQ Completion Queue
CM Communication Management
BTH Base Transport Header
RC Reliable Connection
QPN QP Number
PSN Packet Sequence Number
WQE Work Queue Element
CQE Completion Queue Element
RC Reliable Connection
REQ Connect Request
REP Connect Reply
RTU Ready To Use

### Processing System

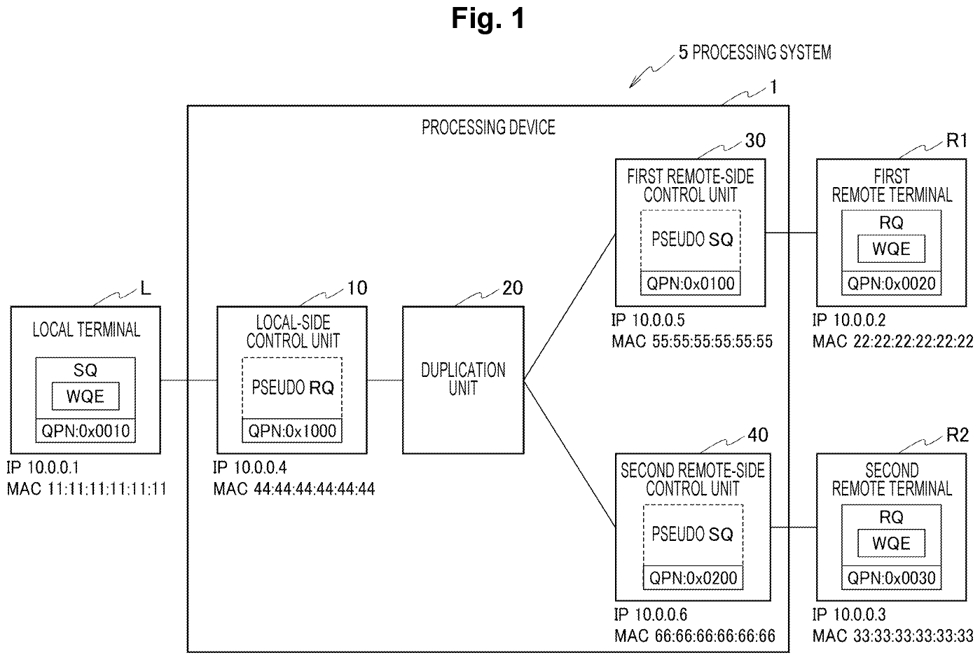

A processing system 5 according to an embodiment of the present invention will be described with reference to FIG. 1. The processing system 5 includes a processing device 1, a local terminal L, a first remote terminal R1, and a second remote terminal R2. In a case where the first remote terminal R1 and the second remote terminal R2 are not distinguished from each other, the first remote terminal R1 and the second remote terminal R2 may be referred to as remote terminals R. In the embodiment of the present invention, a case where processing data is transferred from the local terminal L to the two remote terminals R will be described, but the present invention is not limited thereto. The number of remote terminals R may be two or more.

In the embodiment of the present invention, an RDMA transmission packet P is transmitted by the local terminal L by using a SEND operation scheme (RC) of an RDMA protocol. Processing data to be transferred to the memory of the accelerator of the remote terminal R is set in the RDMA transmission packet P. An RDMA transmission packet P1 is transmitted from the processing device 1 to the first remote terminal R1. The RDMA transmission packet P1 is generated by converting the header of the RDMA transmission packet P by the processing device 1. An RDMA transmission packet P2 is transmitted from the processing device 1 to the second remote terminal R2. The RDMA transmission packet P2 is generated by converting the header of the RDMA transmission packet P by the processing device 1.

In the processing system 5, the local terminal L transmits to the processing device 1 the RDMA transmission packet P in which processing data to be transferred to the memory of the accelerator of each of the first remote terminal R1 and the second remote terminal R2 is set. The processing device 1 converts the header of the received RDMA transmission packet P to generate the RDMA transmission packet P1/P2. The processing device 1 transmits the RDMA transmission packet P1/P2 that has been converted to each of the first remote terminal R1 and the second remote terminal R2. Each of the first remote terminal R1 and the second remote terminal R2 receives from the processing device 1 the RDMA transmission packet P1/P2 and transfers the processing data to the memory of the accelerator. Here, a duplication unit 20 of the processing device 1 is implemented by a computer physically or virtually different from the local terminal L, the first remote terminal R1, and the second remote terminal R2.

In the processing system 5 described above, the processing device 1 generates an RDMA transmission packet Pn corresponding to each of the plurality of remote terminals R from the RDMA transmission packet P received from the local terminal L, and transfers the processing data to each of the plurality of remote terminals R. Since the local terminal L is only required to generate one RDMA transmission packet P regardless of the number of remote terminals R as transfer destinations, the processing load can be reduced as compared with the case of generating an RDMA transmission packet for each of the remote terminals R. In addition, since the processing device 1 generates and transmits a plurality of packets corresponding to the remote terminals R, respectively, the local terminal L is only required to transmit one RDMA transmission packet P regardless of the number of the remote terminals R as transfer destinations, so that the amount of data to be transmitted can be reduced.

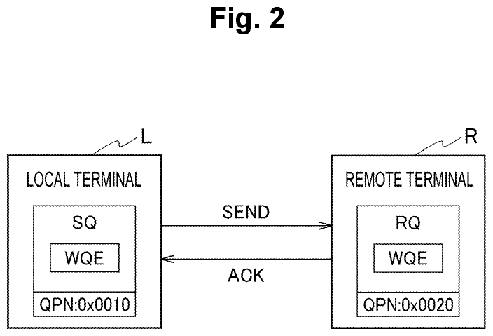

Processing of transmitting a general RDMA transmission packet by P2P will be described with reference to FIG. 2. The local terminal L holds a SQ, and the remote terminal R holds an RQ. The SQ of the local terminal L and the RQ of the remote terminal R form a QP.

Before transmission of an RDMA transmission packet, a connection is established between the local terminal L and the remote terminal R. When the connection is established, the local terminal L sets the values of the Local QPN and the Starting PSN of the SQ in the CM header of an REQ and notifies the remote terminal R of the values. The remote terminal R sets the values of the Local QPN and the Starting PSN of the RQ in the CM header of an REP and notifies the local terminal L of the values. The Local QPN identifies the QP in the local terminal L or the remote terminal R. In the local terminal L or the remote terminal R, the PSN specifies transmitted and received bytes in the processing data specified by bytestreams.

When the connection is established, the processing data is transferred. Data transfer by the SEND operation scheme (RC) of the RDMA protocol will be described. The local terminal L adds a WQE designating the address of the memory area storing the processing data to the SQ. The remote terminal R adds a WQE designating the address of the memory area where the processing data is to be stored to the RQ.

The local terminal L transmits an RDMA transmission packet in which the processing data is set in the payload to the remote terminal R. The QPN of the RQ acquired from the remote terminal R when the connection is established is set in the Destination QP field of the BTH of the RDMA transmission packet to be transmitted first after the connection is established. In the PSN field, the value of the Starting PSN acquired from the remote terminal R when the connection is established is set.

When the remote terminal R receives the RDMA transmission packet and successfully receives the processing data, the remote terminal R adds a CQE to a CQ and transmits an ACK packet to the local terminal L. The QPN of the SQ is set in the Destination QP field of the BTH of the ACK packet. In the PSN field, the value of the Starting PSN transmitted to the remote terminal R when the connection is established is set.

When the local terminal L receives the ACK packet from the remote terminal R, the local terminal L adds a CQE to a CQ. At this time, the WQE is released from the SQ.

After the connection is established, values incremented from the Starting PSN are set to PSNs set to the second and subsequent RDMA transmission packets.

### Processing Device

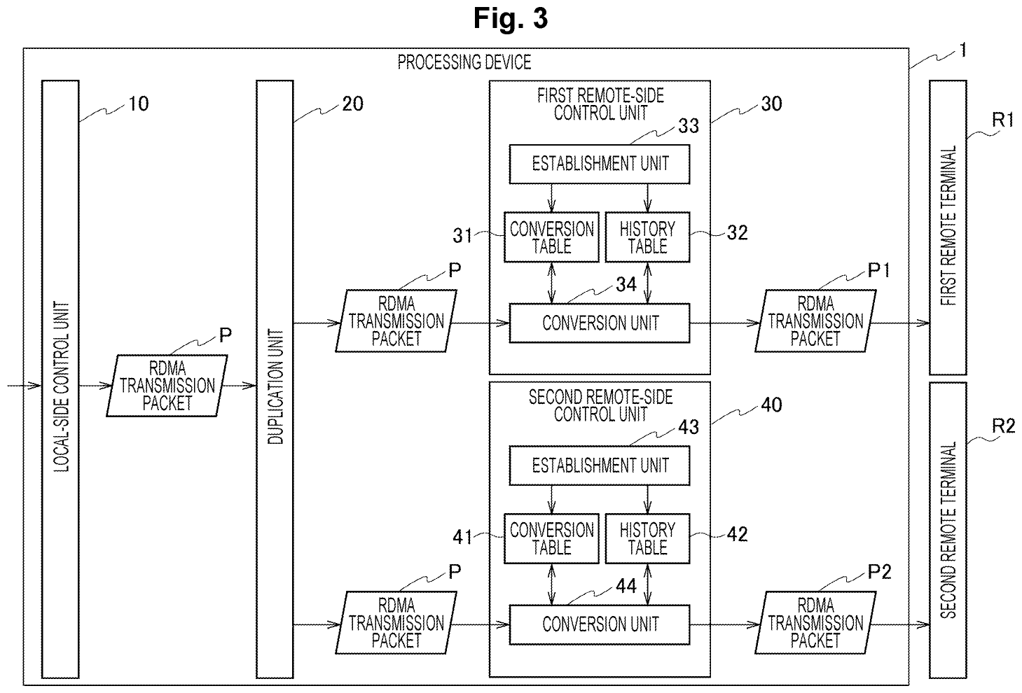

The processing device 1 according to the embodiment of the present invention will be described with reference to FIGS. 1 and 3.

The processing device 1 includes a local-side control unit 10, the duplication unit 20, a first remote-side control unit 30, and a second remote-side control unit 40. The first remote-side control unit 30 and the second remote-side control unit 40 have similar functions although the remote terminals as the transfer destinations are different. The processing device 1 includes as many remote-side control units as the number of remote terminals R which are the transfer destinations of the processing data.

In the embodiment of the present invention, a case where one computer implements a processing unit of each of the local-side control unit 10, the duplication unit 20, the first remote-side control unit 30, and the second remote-side control unit 40 will be described, but the present invention is not limited thereto. The processing units may be implemented by a plurality of computers in a distributed manner.

As illustrated in FIG. 1, in the processing system 5, the local terminal L has an SQ. The first remote terminal R1 and the second remote terminal R2 each have an RQ. The local-side control unit 10 functions as a pseudo RQ for the SQ of the local terminal L. The first remote-side control unit 30 functions as a pseudo SQ for the RQ of the first remote terminal R1. The second remote-side control unit 40 functions as a pseudo SQ for the RQ of the second remote terminal R2. The duplication unit 20 inputs an RDMA transmission packet P received by the local-side control unit 10 to each of the first remote-side control unit 30 and the second remote-side control unit 40.

The local-side control unit 10 establishes a connection with the local terminal L and receives an RDMA transmission packet P from the local terminal L.

The duplication unit 20 duplicates the RDMA transmission packet P received from the local terminal L and inputs the duplicated RDMA transmission packets P to the first remote-side control unit 30 and the second remote-side control unit 40.

The first remote-side control unit 30 generates an RDMA transmission packet P1 obtained by converting the header of the input RDMA transmission packet P, and transmits the RDMA transmission packet P1 to the first remote terminal R1. As illustrated in FIG. 3, the first remote-side control unit 30 includes the respective data of a conversion table 31 and a history table 32, and the respective functions of an establishment unit 33 and a conversion unit 34. The data is stored in a storage device such as a memory 902 or a storage 903. The functions are implemented by a CPU 901.

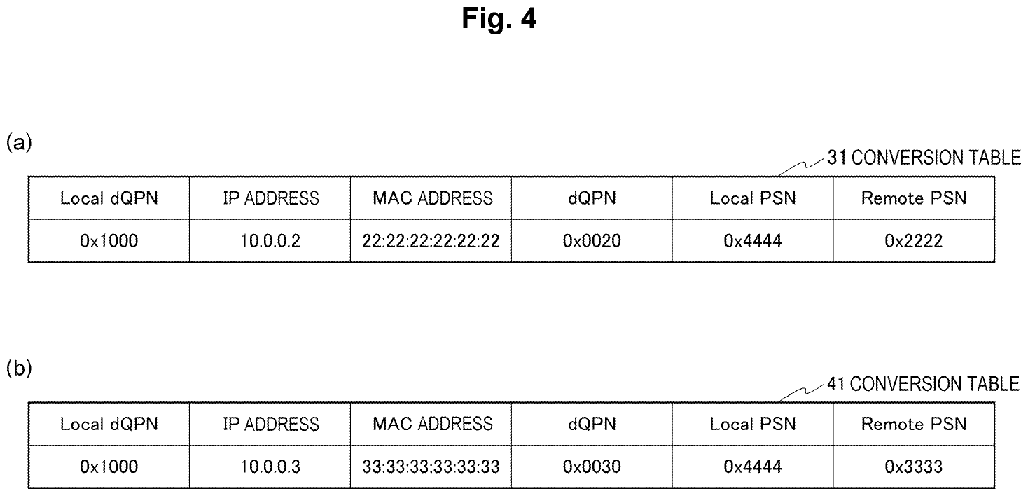

As illustrated in FIG. 4(a), the conversion table 31 includes data items: Local dQPN, IP address, MAC address, dQPN, Local PSN, and Remote PSN. Before the first remote-side control unit 30 establishes a connection with the first remote terminal R1, a NULL value is set to each item of the conversion table 31.

The Local dQPN is the counter QPN of the local terminal L. The Local dQPN is a Destination QP included in the BTH of the RDMA transmission packet P transmitted by the local terminal L. The Local dQPN is set when an RDMA transmission packet P is received for the first time after the local terminal L establishes a connection with the local-side control unit 10.

The IP address is the IP address of the first remote terminal R1. At the time of connection establishment, the Source IP address included in an REP received from the first remote terminal R1 is set as the IP address.

The MAC address is the MAC address of the first remote terminal R1. At the time of connection establishment, the Source MAC address included in the REP received from the first remote terminal R1 is set as the MAC address.

The dQPN is a QPN of the first remote terminal R1. At the time of connection establishment, the Local QPN included in the REP received from the first remote terminal R1 is set as the dQPN.

The Local PSN is a PSN of the RDMA transmission packet P transmitted from the local terminal L. When an RDMA transmission packet P is received for the first time after a connection is established, the PSN included in the BTH of the RDMA transmission packet P is set as the Local PSN. Thereafter, the value of the Local PSN is incremented by one each time an RDMA transmission packet P is received. In general, the value of Local PSN in the conversion table 31 matches the PSN included in the BTH of the RDMA transmission packet P transmitted from the local terminal L.

The Remote PSN is a PSN of the RDMA transmission packet P1 to be transferred to the first remote terminal R1. At the time of connection establishment, the Starting PSN included in the REP received from the first remote terminal R1 is set as the Remote PSN. Thereafter, the value of the Remote PSN is incremented by one each time an RDMA transmission packet P is received from the local terminal L.

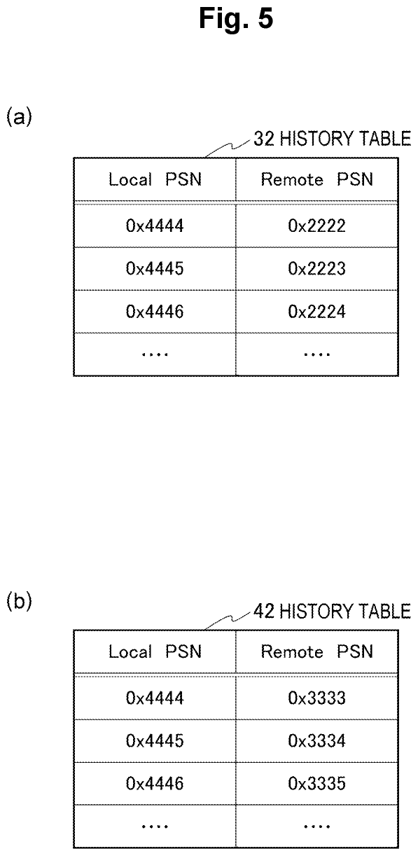

The history table 32 is data of a history of values of the Local PSN and the Remote PSN in the conversion table 31. As illustrated in FIG. 5(a), the history table 32 includes the Local PSNs and the Remote PSNs. When the values in the conversion table 31 are registered, the Local PSN and the Remote PSN at the time of registration are set in the first row. When the values in the conversion table 31 are updated, specifically, each time an RDMA transmission packet P is received from the local terminal L, the updated Local PSN and Remote PSN are set in a new row. The history table 32 is referred to in a case where the first remote-side control unit 30 specifies the RDMA transmission packet P retransmission processing of which is requested when the first remote-side control unit 30 detects a packet loss of the RDMA transmission packet P1.

The establishment unit 33 establishes a connection with the first remote terminal R1. The establishment unit 33 acquires a QPN and a Starting PSN from the first remote terminal R1 when the connection is established. The establishment unit 33 sets the acquired QPN as the dQPN in the conversion table 31. The establishment unit 33 sets the Starting PSN as the Remote PSN in the conversion table 31 and the Remote PSN in the first row of the history table 32. The establishment unit 33 sets the Source IP address and the Source MAC address of the first remote terminal R1 as the IP address and the MAC address in the conversion table 31.

The conversion unit 34 converts the Destination QP and the PSN of the BTH of the RDMA transmission packet P input from the duplication unit 20. The conversion unit 34 converts the Source IP address and the Source MAC address into the IP address and the MAC address of the first remote-side control unit 30. The conversion unit 34 converts the Destination IP address and the Destination MAC address into the IP address and the MAC address registered in the conversion table 31, specifically, the IP address and the MAC address of the first remote terminal R1. The conversion unit 34 transmits the converted RDMA transmission packet P1 to the first remote terminal R1.

First, conversion of the Destination QP will be described. The conversion unit 34 converts the Destination QP of the BTH of the RDMA transmission packet P input from the duplication unit 20 into the QPN acquired from the first remote terminal R1. At this time, the conversion unit 34 converts the value of the Destination QP of the BTH of the RDMA transmission packet P input from the duplication unit 20 into the value of the dQPN in the conversion table 31.

Next, conversion of the PSN will be described. The PSN conversion method is different between the first RDMA transmission packet P received for the first time after a connection is established and an RDMA transmission packet P received thereafter.

When the first RDMA transmission packet P is input for the first time after a connection is established, the conversion unit 34 sets the PSN of the BTH of the first RDMA transmission packet P as the Local PSN in the conversion table 31 and the Local PSN in the first row of the history table 32. The conversion unit 34 converts the value of the PSN of the BTH of the first RDMA transmission packet P into the value of the Remote PSN in the conversion table 31, specifically, the value of the Starting PSN acquired from the first remote terminal R1. At this time, the conversion unit 34 sets the Destination QP of the BTH of the RDMA transmission packet P as the Local dQPN in the conversion table 31.

When the second RDMA transmission packet P is input after the connection is established and the first RDMA transmission packet P is input, the conversion unit 34 increments each of the Local PSN and the Remote PSN in the conversion table 31, and sets the incremented values as the Local PSN and the Remote PSN in the second row of the history table 32. The conversion unit 34 converts the value of the PSN of the BTH of the second RDMA transmission packet P into the value of the Remote PSN in the conversion table 31, specifically, the value of the PSN obtained by incrementing the Starting PSN acquired from the first remote terminal R1.

The conversion unit 34 updates the Local PSN in the conversion table 31 to a value incremented according to the number of RDMA transmission packets P input after the connection is established. The conversion unit 34 sets the updated Local PSN as the Local PSN in the nth row in the history table 32, n being the number of RDMA transmission packets P input after the connection is established. As illustrated in FIG. 5(a), when the first RDMA transmission packet P is input after the connection is established, 0x4444, which is the PSN of the BTH of the first RDMA transmission packet P is set as the Local PSN in the first row. When the second RDMA transmission packet P is input after the connection is established, 0x4445 obtained by incrementing 0x4444 is set as the Local PSN in the second row. When the third RDMA transmission packet P is input after the connection is established, 0x4446 obtained by incrementing 0x4445 is set as the Local PSN in the third row.

The conversion unit 34 updates the Remote PSN in the conversion table 31 to a value incremented according to the number of RDMA transmission packets P input after the connection is established. The conversion unit 34 sets the updated Remote PSN as the Remote PSN in the nth row in the history table 32, n being the number of RDMA transmission packets P input after the connection is established. As illustrated in FIG. 5(a), 0x2222, which is the Starting PSN acquired in the REP from the remote terminal R when a connection is established with the first remote terminal R1, is set as the Remote PSN in the first row in the history table 32. At a time point when the first RDMA transmission packet P is input after the connection is established, a value is already set as the Remote PSN in the history table 32. When the second RDMA transmission packet P is input after the connection is established, 0x2223 obtained by incrementing 0x2222 is set as the Remote PSN in the second row. When the third RDMA transmission packet P is input after the connection is established, 0x2224 obtained by incrementing 0x2223 is set as the Remote PSN in the third row.

The conversion unit 34 may determine whether or not to process the RDMA transmission packet by referring to the Destination QP of the BTH of the RDMA transmission packet input from the duplication unit 20. In a case where the Destination QP of the BTH of the second RDMA transmission packet P matches the Destination QP of the BTH of the first RDMA transmission packet P, the conversion unit 34 transmits the converted second RDMA transmission packet to the first remote terminal. In a case where the destination QPs do not match, the conversion unit 34 discards the second RDMA transmission packet P. In a case where the same value as the Destination QP of the BTH of the previously received RDMA transmission packet P is set as the Destination QP of the BTH of the newly received RDMA transmission packet P, the newly received RDMA transmission packet P is determined to be a valid packet transmitted from the same transmission source as that of the previously received RDMA transmission packet P. In a case where a different value is set, the newly received RDMA transmission packet P is determined to be an invalid packet transmitted from a transmission source different from that of the previously received RDMA transmission packet P, and is discarded.

The second remote-side control unit 40 generates an RDMA transmission packet P2 obtained by converting the header of the input RDMA transmission packet P, and transmits the RDMA transmission packet P2 to the second remote terminal R2. As illustrated in FIG. 3, the second remote-side control unit 40 includes a conversion table 41, a history table 42, an establishment unit 43, and a conversion unit 44. The data is stored in a storage device such as a memory 902 or a storage 903. The functions are implemented by a CPU 901.

As illustrated in FIG. 4(b), the conversion table 41 has a data configuration similar to that of the conversion table 31 of the first remote-side control unit 30. As illustrated in FIG. 5(b), the history table 42 has a data configuration similar to that of the history table 32 of the first remote-side control unit 30. The establishment unit 43 and the conversion unit 44 have functions similar to those of the establishment unit 33 and the conversion unit 34 of the first remote-side control unit 30, respectively.

The establishment unit 43 establishes a connection with the second remote terminal R2. The establishment unit 43 acquires a QPN and a Starting PSN from the second remote terminal R2 when the connection is established. The establishment unit 43 sets the acquired QPN as the dQPN in the conversion table 41. The establishment unit 43 sets the Starting PSN as the Remote PSN in the conversion table 41 and the Remote PSN in the first row of the history table 42. The establishment unit 43 sets the Source IP address and the Source MAC address of the first remote terminal R1 as the IP address and the MAC address in the conversion table 41.

The conversion unit 44 converts the Destination QP and the PSN of the BTH of the RDMA transmission packet P input from the duplication unit 20. The conversion unit 44 converts the Source IP address and the Source MAC address into the IP address and the MAC address of the second remote-side control unit 40. The conversion unit 44 converts the Destination IP address and the Destination MAC address into the IP address and the MAC address registered in the conversion table 41, specifically, the IP address and the MAC address of the second remote terminal R2. The conversion unit 44 transmits the converted RDMA transmission packet P2 to the second remote terminal R2.

Conversion of the Destination QP and the PSN of the BTH of the RDMA transmission packet P will be described.

The conversion unit 44 converts the value of the Destination QP of the BTH of the RDMA transmission packet P input from the duplication unit 20 into the value of the dQPN in the conversion table 41, specifically, the QPN acquired from the second remote terminal R2. At this time, the conversion unit 44 sets the value of the Destination QP of the BTH of the RDMA transmission packet P input from the duplication unit 20 as the value of the dQPN in the conversion table 41.

When the first RDMA transmission packet P is input for the first time after the connection is established, the conversion unit 44 sets the PSN of the BTH of the first RDMA transmission packet P as the Local PSN in the conversion table 41 and the Local PSN in the first row of the history table 42. The conversion unit 44 converts the value of the PSN of the BTH of the first RDMA transmission packet P into the value of the Remote PSN in the conversion table 41, specifically, the value of the Starting PSN acquired from the second remote terminal R2. At this time, the conversion unit 44 sets the Destination QP of the BTH of the RDMA transmission packet P as the Local dQPN in the conversion table 41.

When the second RDMA transmission packet P is input after the connection is established and the first RDMA transmission packet P is input, the conversion unit 44 increments each of the Local PSN and the Remote PSN in the conversion table 41, and sets the incremented values as the Local PSN and the Remote PSN in the second row of the history table 42. The conversion unit 44 converts the value of the PSN of the BTH of the second RDMA transmission packet P into the value of the Remote PSN in the conversion table 41, specifically, the value of the PSN obtained by incrementing the Starting PSN acquired from the second remote terminal R2.

The conversion unit 44 updates the Local PSN and the Remote PSN in the conversion table 41 to values incremented according to the number of RDMA transmission packets P input after the connection is established. The conversion unit 44 sets the updated Local PSN and Remote PSN as the Local PSN and the Remote PSN in the nth row in the history table 42, n being the number of RDMA transmission packets P input after the connection is established.

### Connection Establishment

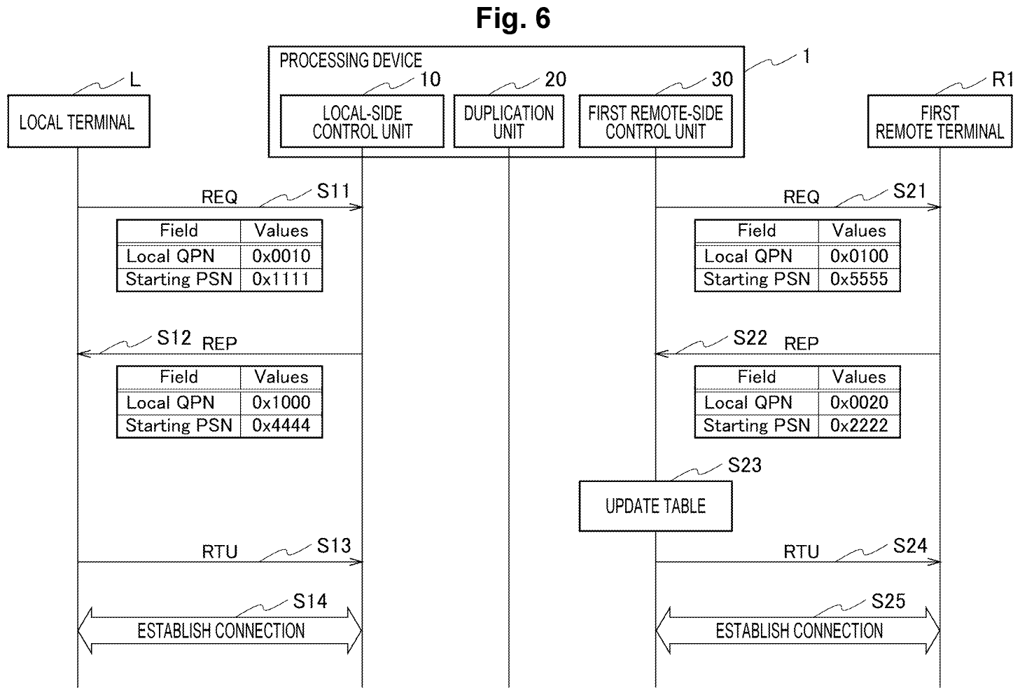

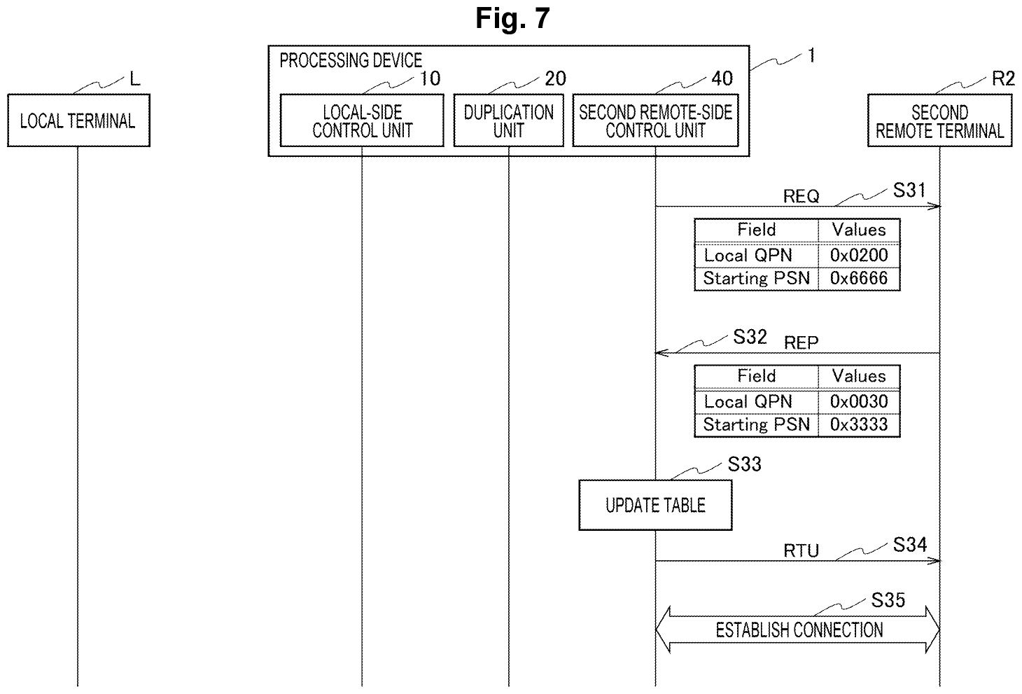

Connection establishment processing in the processing system 5 will be described with reference to FIGS. 6 and 7.

First, a connection is established between the local terminal L and the local-side control unit 10. In step S11, the local terminal L transmits a REQ to the local-side control unit 10. The REQ includes the Local QPN and the Starting PSN of the local terminal L. In step S12, the local-side control unit 10 transmits a REP. The REP includes the Local QPN and the Starting PSN of the local-side control unit 10. In step S13, the local terminal L transmits RTU. In step S14, a connection is established between the local terminal L and the local-side control unit 10.

Next, a connection is established between the first remote-side control unit 30 and the first remote terminal R1. In step S21, the first remote-side control unit 30 transmits a REQ to the first remote terminal R1. The REQ includes the Local QPN and the Starting PSN of the first remote-side control unit 30. In step S22, the first remote terminal R1 transmits a REP. The REP includes the Local QPN and the Starting PSN of the first remote terminal R1.

In step S23, the first remote-side control unit 30 updates the conversion table 31 and the history table 32 by using the Local QPN and the Starting PSN included in the REP. The first remote-side control unit 30 registers the Local QPN received in step S22 as the dQPN in the conversion table 31. The first remote-side control unit 30 registers the Starting PSN received in step S22 as the Remote PSN in the conversion table 31 and the Remote PSN in the first row of the history table 32. The first remote-side control unit 30 further sets the Source IP address and the Source MAC address included in the REP as the IP address and the MAC address in the conversion table 31.

In step S24, the first remote-side control unit 30 transmits RTU. In step S25, a connection is established between the first remote-side control unit 30 and the first remote terminal R1.

Furthermore, a connection is established between the second remote-side control unit 40 and the second remote terminal R2. In step S31, the second remote-side control unit 40 transmits a REQ to the second remote terminal R2. The REQ includes the Local QPN and the Starting PSN of the second remote-side control unit 40. In step S32, the second remote terminal R2 transmits a REP. The REP includes the Local QPN and the Starting PSN of the second remote terminal R2.

In step S33, the second remote-side control unit 40 updates the conversion table 41 and the history table 42 by using the Local QPN and the Starting PSN included in the REP. The second remote-side control unit 40 registers the Local QPN received in step S32 as the dQPN in the conversion table 41. The second remote-side control unit 40 registers the Starting PSN received in step S32 as the Remote PSN in the conversion table 41 and the Remote PSN in the first row of the history table 42.

In step S34, the second remote-side control unit 40 transmits RTU. In step S35, a connection is established between the second remote-side control unit 40 and the second remote terminal R2.

### Data Transfer

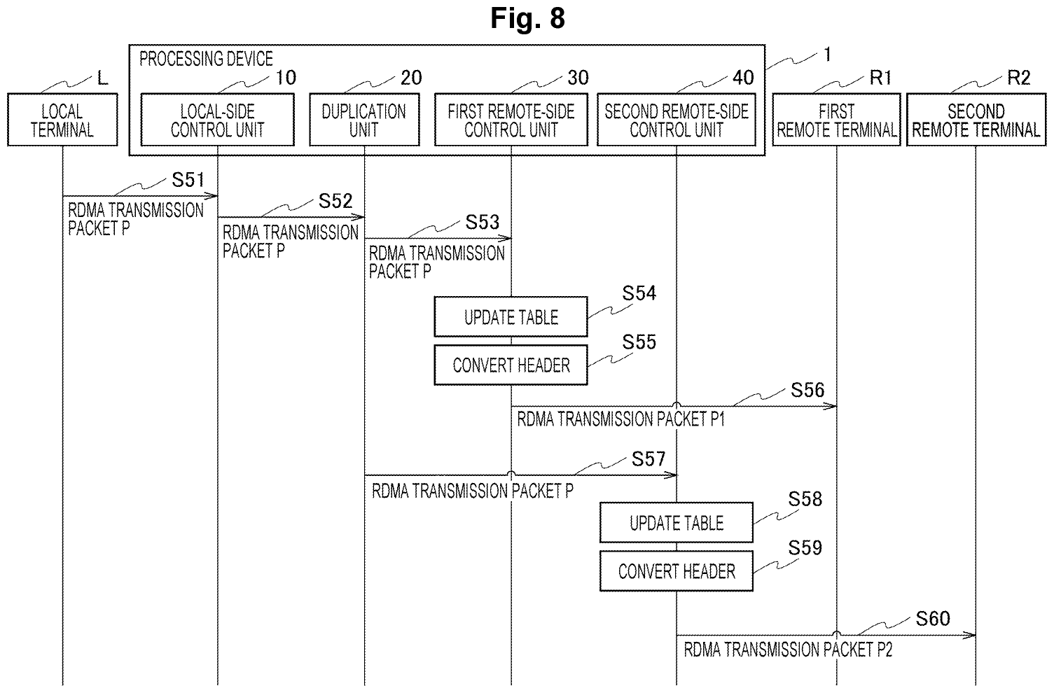

Data transfer processing in the processing system 5 will be described with reference to FIG. 8.

When the local terminal L transmits an RDMA transmission packet P in step S51, the local-side control unit 10 receives the RDMA transmission packet P. In step S52, the local-side control unit 10 transmits the RDMA transmission packet P to the duplication unit 20.

The duplication unit 20 transmits the received RDMA transmission packet P to the first remote-side control unit 30 in step S53, and transmits the RDMA transmission packet P to the second remote-side control unit 40 in step S57.

When the first remote-side control unit 30 receives the RDMA transmission packet P, the first remote-side control unit 30 updates the conversion table 31 and the history table 32 in step S54. The first remote-side control unit 30 sets the Destination QP of the BTH of the RDMA transmission packet P input from the duplication unit 20 as the Local dQPN in the conversion table 31. In a case where the received RDMA transmission packet P is the RDMA transmission packet received for the first time after a connection is established, the first remote-side control unit 30 sets the PSN of the BTH of the received RDMA transmission packet P as the Local PSN in the conversion table 31 and the Local PSN in the first row of the history table 32. In a case where the received RDMA transmission packet P is the second or subsequent RDMA transmission packet P received after the connection is established, the first remote-side control unit 30 updates the Local PSN and the Remote PSN in the conversion table 31 to values incremented according to the number of RDMA transmission packets P input after the connection is established. The first remote-side control unit 30 sets the updated Local PSN and Remote PSN as the Local PSN and the Remote PSN in the nth row in the history table 32, n being the number of RDMA transmission packets P input after the connection is established.

In step S55, the first remote-side control unit 30 refers to the updated conversion table 31, converts the header of the input RDMA transmission packet P, and generates an RDMA transmission packet P1. The first remote-side control unit 30 sets the Destination QP of the BTH of the RDMA transmission packet P input from the duplication unit 20 as the Local dQPN in the conversion table 31. The first remote-side control unit 30 converts the value of the PSN of the BTH of the RDMA transmission packet P into the value of the Remote PSN in the conversion table 31. The first remote-side control unit 30 converts the Source IP address and the Source MAC address into the IP address and the MAC address of the first remote-side control unit 30. The first remote-side control unit 30 converts the Destination IP address and the Destination MAC address into the IP address and the MAC address registered in the conversion table 31, specifically, the IP address and the MAC address of the first remote terminal R1.

In step S56, the first remote-side control unit 30 transmits the RDMA transmission packet P1 obtained by changing the header in step S55 to the first remote terminal R1.

In steps S58 to S60, processing similar to that in steps S54 to S56 is performed. When the second remote-side control unit 40 receives the RDMA transmission packet P, the second remote-side control unit 40 updates the conversion table 41 and the history table 42 in step S58. In step S59, the second remote-side control unit 40 refers to the updated conversion table 41, converts the header of the input RDMA transmission packet P, and generates an RDMA transmission packet P2. In step S60, the second remote-side control unit 40 transmits the RDMA transmission packet P2 obtained by changing the header in step S59 to the second remote terminal R2.

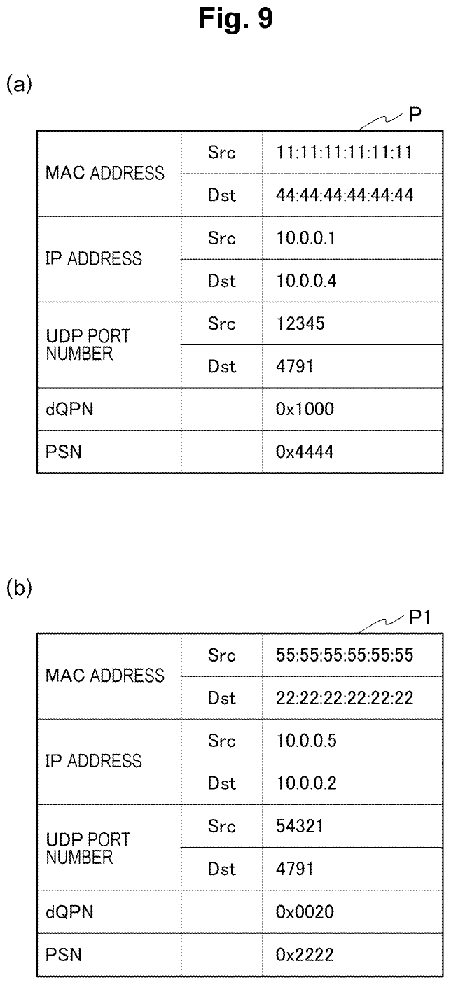

Examples of the header of the RDMA transmission packet P transmitted from the local terminal L in step S51 of FIG. 8 and the header of the RDMA transmission packet P1 obtained by converting the header by the first remote-side control unit 30 in step S55 will be described with reference to FIG. 9.

FIG. 9(a) is an example of the header of the RDMA transmission packet P transmitted from the local terminal L. In the RDMA transmission packet P, the MAC address, the IP address, and the UDP port number of the local terminal L are set as the MAC address, the IP address, and the UDP port number of Src (Source). The MAC address, the IP address, and the UDP port number of the local-side control unit 10 are set as the MAC address, the IP address, and the UDP port number of Dst (Destination). The QPN of the local-side control unit 10 is set as the dQPN. The PSN of the local terminal L is set as the PSN.

FIG. 9(b) illustrates an example of the header of the RDMA transmission packet P1 obtained by converting the header by the first remote-side control unit 30. In the RDMA transmission packet P1, the MAC address, the IP address, and the UDP port number of the first remote-side control unit 30 are set as the MAC address, the IP address, and the UDP port number of Src (Source). The MAC address, the IP address, and the UDP port number of the first remote terminal R1 are set as the MAC address, the IP address, and the UDP port number of Dst (Destination). The QPN of the first remote terminal R1 is set as the dQPN. The PSN of the first remote-side control unit 30 is set as the PSN.

Note that, in FIGS. 9(a) and 9(b), a randomly determined number is set as the Source UDP port number. In a case where an RDMA connection is established using the mechanism of ROCEv2, a fixedly determined number is set as the Destination UDP port number. Therefore, in the RDMA transmission packet P2, the number allocated to the first remote-side control unit 30 is set as the Source UDP port number, and the same number “4791” as the Destination UDP port number in the RDMA transmission packet P1 is set as the Destination UDP port number.

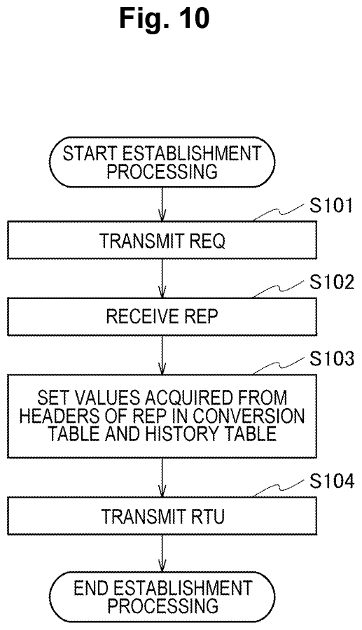

Processing of the establishment unit 33 of the first remote-side control unit 30 will be described with reference to FIG. 10.

In step S101, the establishment unit 33 transmits an REQ to the first remote terminal R1. In step S102, the establishment unit 33 receives an REP from the first remote terminal R1.

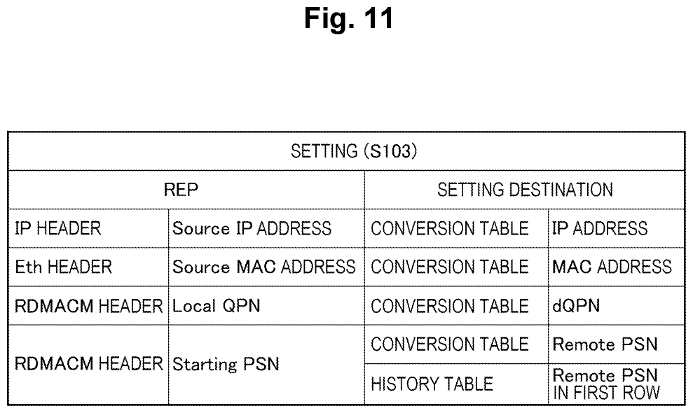

In step S103, the establishment unit 33 sets the values acquired from the headers of the REP in the conversion table 31 and the history table 32. Specifically, as illustrated in FIG. 11, the establishment unit 33 sets the Source IP address of the IP header of the REP as the IP address in the conversion table 31. The establishment unit 33 sets the Source MAC address of the Eth header as the MAC address in the conversion table 31. The establishment unit 33 sets the Local QPN of the RDMACM header as the dQPN in the conversion table 31. The establishment unit 33 sets the Starting PSN of the RDMACM header as the Remote PSN in the conversion table 31 and further sets the Starting PSN as the Remote PSN in the first row of the history table 32.

When the setting of the conversion table 31 and the history table 32 is completed, the establishment unit 33 transmits RTU to the first remote terminal R1 in step S104.

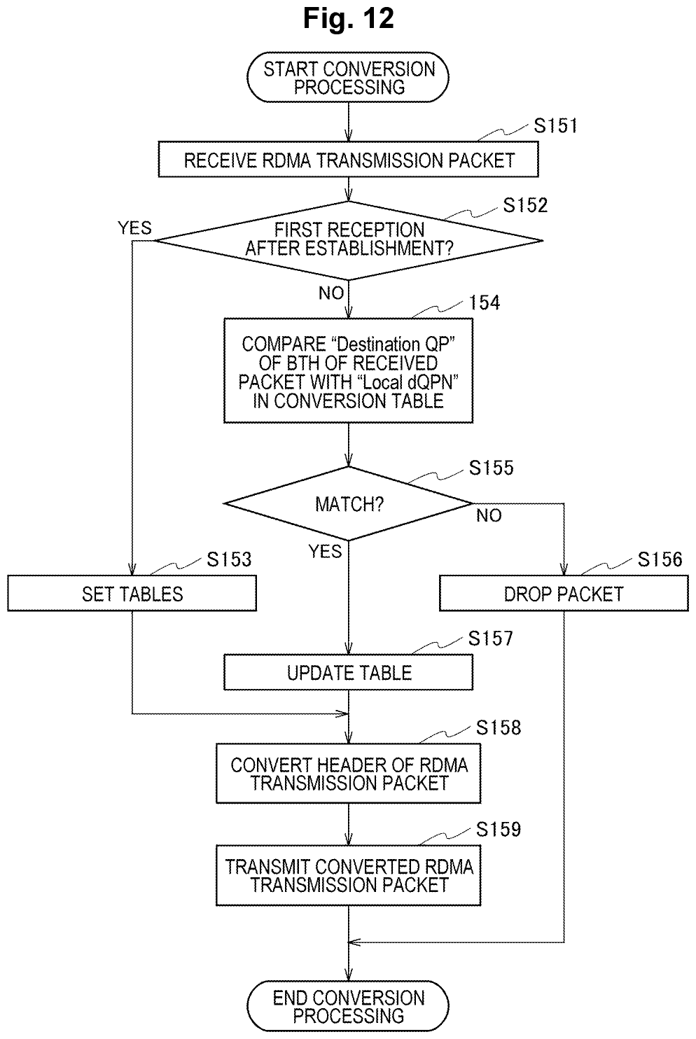

Processing of the conversion unit 34 of the first remote-side control unit 30 will be described with reference to FIG. 12.

In step S151, the conversion unit 34 receives an RDMA transmission packet P from the duplication unit 20. In step S152, the conversion unit 34 determines whether or not the RDMA transmission packet is the RDMA transmission packet that is received for the first time after a connection is established.

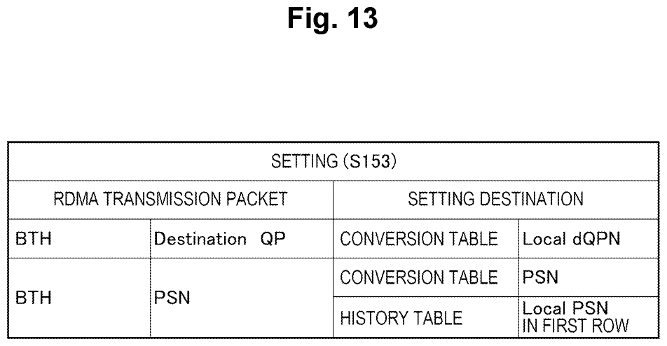

In a case where it is determined in step S152 that it is the first reception, the processing proceeds to step S153. In step S153, the conversion unit 34 sets the conversion table 31 and the history table 32. Specifically, as illustrated in FIG. 13, the conversion unit 34 sets the Destination QP of the BTH of the RDMA transmission packet P as the Local dQPN in the conversion table 31. The conversion unit 34 sets the PSN of the BTH as the PSN in the conversion table 31, and further sets the PSN as the Local PSN in the first row of the history table 32. After the setting, the processing proceeds to step S158.

In a case where it is determined in step S152 that it is not the first reception, the processing proceeds to step S154. In step S154, the conversion unit 34 compares the Destination QP of the BTH of the received packet with the Local dQPN in the conversion table 31, and determines whether or not the Destination QP and the Local dQPN match in step S155. In a case where the Destination QP and the Local dQPN do not match, the conversion unit 34 determines that the transmission source of the received packet is not the local terminal L and drops the packet in step S156, and the processing ends.

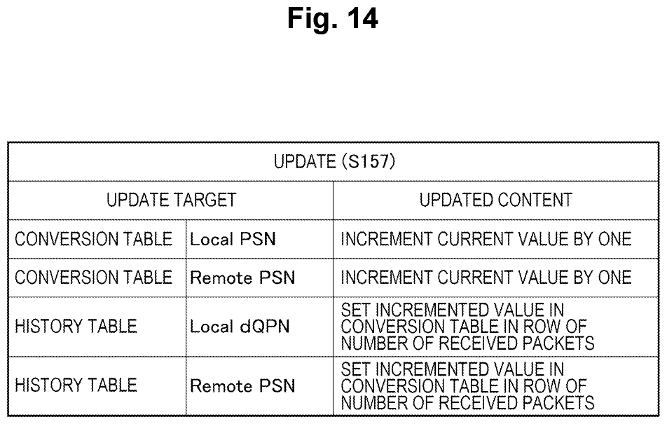

In a case where it is determined in step S152 that it is not the first reception and it is determined in step S155 that the Destination QP of the BTH of the received packet matches the Local dQPN in the conversion table 31, the conversion unit 34 updates the conversion table 31 and the history table 32 in step S157. Specifically, as illustrated in FIG. 14, the conversion unit 34 increments the current value of the Local PSN of the conversion table 31 by one to update the current value. The conversion unit 34 increments the current value of the Remote PSN in the conversion table 31 by one and updates the current value. The conversion unit 34 sets the incremented Local PSN and Remote PSN in the conversion table 31 as the Local dQPN and the Remote PSN in the nth row in the history table 32, n being the number of packets received after the connection is established.

In step S158, the conversion unit 34 converts the header of the received RDMA transmission packet P to generate an RDMA transmission packet P1. The conversion unit 34 sets the Destination QP of the BTH of the RDMA transmission packet P input from the duplication unit 20 as the Local dQPN in the conversion table 31. The conversion unit 34 converts the value of the PSN of the BTH of the RDMA transmission packet P into the value of the Remote PSN in the conversion table 31. The conversion unit 34 converts the Source IP address and the Source MAC address into the IP address and the MAC address of the first remote-side control unit 30. The conversion unit 34 converts the Destination IP address and the Destination MAC address into the IP address and the MAC address registered in the conversion table 31, specifically, the IP address and the MAC address of the first remote terminal R1.

In step S159, the conversion unit 34 transmits the RDMA transmission packet P1 that has been converted to the first remote terminal R1.

In the processing system 5 according to the embodiment of the present invention, the processing device 1 generates and transmits the RDMA transmission packet P1 addressed to the first remote terminal R1 and the RDMA transmission packet P2 addressed to the second remote terminal R2 from the RDMA transmission packet P transmitted from the local terminal L. The local terminal L is only required to generate the RDMA transmission packet P and transmit the RDMA transmission packet P to the processing device 1 regardless of the number of remote terminals R, so that the load on the local terminal L can be reduced.

### Modification

In the processing system 5 according to the embodiment of the present invention, the local terminal L, the processing device 1, the first remote terminal R1, and the second remote terminal R2 are implemented by physically different computers, so that it is possible to obtain an effect of reducing the load on the local terminal that transfers data to the plurality of remote terminals. More specifically, since the processing system 5 implements the duplication unit 20 by a computer that is physically or virtually different from the local terminal L, the first remote terminal R1, and the second remote terminal R2, it is possible to reduce a load on the local terminal L that transfers data to the plurality of remote terminals R.

The functions of the local-side control unit 10, the duplication unit 20, the first remote-side control unit 30, and the second remote-side control unit 40 of the processing device 1 may be implemented by different computers. Furthermore, each of the functions may be implemented by a computer having another function. For example, the local-side control unit 10 of the processing device 1 may be implemented by a network interface card (NIC) of the local terminal L, the first remote-side control unit 30 may be implemented by an NIC of the first remote terminal R1, or the second remote-side control unit 40 may be implemented by an NIC of the second remote terminal R2.

In addition, in the embodiment of the present invention, a case where the duplication unit 20 is implemented as one function of a computer will be described, but the present invention is not limited thereto. The duplication unit 20 may be implemented as one function of a communication control device. In that case, a packet may be duplicated by electrical processing or optical processing. In duplication by electrical processing, a multicast function of an IP router, or a device such as a packet broker, a network tap, or port mirroring of an L2 switch electrically converts a signal into data and duplicates the electrically converted data. In duplication by optical processing, a device such as an optical splitter or an optical tap demultiplexes a signal as a physical phenomenon of light.

As described above, various forms can be considered for implementation of the processing system 5.

As the processing device 1 of the present embodiment described above, for example, a general-purpose computer system including the central processing unit (CPU, processor) 901, the memory 902, the storage 903 (hard disk drive (HDD), solid state drive (SSD)), a communication device 904, an input device 905, and an output device 906 is used. In the computer system, each function of the processing device 1 is implemented by the CPU 901 executing a program loaded on the memory 902.

Note that the processing device 1 may be implemented by one computer, or may be implemented by a plurality of computers. In addition, the processing device 1 may be a virtual machine that is implemented by a computer.

The program of the processing device 1 can be stored in a computer-readable recording medium such as an HDD, an SSD, a universal serial bus (USB) memory, a compact disc (CD), or a digital versatile disc (DVD), or can be distributed via a network.

Note that the present invention is not limited to the above embodiment, and various modifications can be made within the scope of the spirit of the present invention.

### Reference Signs List

1 Processing device
5 Processing system
10 Local-side control unit
20 Duplication unit
30, 40 Remote-side control unit
31, 41 Conversion table
32, 42 History table
33, 43 Establishment unit
34, 44 Conversion unit
901 CPU
902 Memory
903 Storage
904 Communication device
905 Input device
906 Output device
L Local terminal
R Remote terminal

1. A processing system comprising: a local terminal; a first remote terminal; a second remote terminal; and a processing device, wherein
the local terminal
transmits, to the processing device, an RDMA transmission packet in which processing data to be transferred to a memory of an accelerator of each of the first remote terminal and the second remote terminal is set,
the processing device includes:
a local-side control unit, including one or more processors, configured to establish a connection with the local terminal, and receives the RDMA transmission packet from the local terminal;
a first remote-side control unit, including one or more processors, configured to establish a connection with the first remote terminal;
a second remote-side control unit, including one or more processors, configured to establish a connection with the second remote terminal; and
a duplication unit, including one or more processors, configured to input the RDMA transmission packet to the first remote-side control unit and the second remote-side control unit,
the first remote-side control unit
acquires a QPN from the first remote terminal when a connection is established,
converts a Destination QP of a base transport header (BTH) of the RDMA transmission packet into the QPN acquired from the first remote terminal, and transmits a converted RDMA transmission packet to the first remote terminal,
the second remote-side control unit
acquires a QPN from the second remote terminal when a connection is established,
converts the Destination QP of the BTH of the RDMA transmission packet into the QPN acquired from the second remote terminal, and transmits a converted RDMA transmission packet to the second remote terminal,
the first remote terminal
receives the converted RDMA transmission packet and transferring the processing data to the memory of the accelerator, and
the second remote terminal
receives the converted RDMA transmission packet and transferring the processing data to the memory of the accelerator.

2. A processing device comprising:
a local-side control unit, including one or more processors, configured to establish a connection with a local terminal, and receives, from the local terminal, an RDMA transmission packet in which processing data to be transferred to a memory of an accelerator of each of a first remote terminal and a second remote terminal is set;
a first remote-side control unit, including one or more processors, configured to establish a connection with the first remote terminal;
a second remote-side control unit, including one or more processors, configured to establish a connection with the second remote terminal; and
a duplication unit, including one or more processors, configured to input the RDMA transmission packet to the first remote-side control unit and the second remote-side control unit, wherein
the first remote-side control unit
acquires a QPN from the first remote terminal when a connection is established,
converts a Destination QP of a BTH of the RDMA transmission packet into the QPN acquired from the first remote terminal, and transmits a converted RDMA transmission packet to the first remote terminal, and
the second remote-side control unit
acquires a QPN from the second remote terminal when a connection is established,
converts the Destination QP of the BTH of the RDMA transmission packet into the QPN acquired from the second remote terminal, and transmits a converted RDMA transmission packet to the second remote terminal.

3. The processing device according to claim 2, wherein
the first remote-side control unit acquires a Starting PSN from the first remote terminal when a connection is established, and
converts a PSN of a BTH of a first RDMA transmission packet into the Starting PSN acquired from the first remote terminal when the first RDMA transmission packet is input after the connection is established, and transmits a converted first RDMA transmission packet to the first remote terminal.

4. The processing device according to claim 3, wherein,
when a second RDMA transmission packet is input after the connection is established and the first RDMA transmission packet is input, the first remote-side control unit converts a PSN of a BTH of the second RDMA transmission packet into a PSN obtained by incrementing the Starting PSN acquired from the first remote terminal, and transmits a converted second RDMA transmission packet to the first remote terminal.

5. The processing device according to claim 4, wherein the first remote-side control unit
transmits the converted second RDMA transmission packet to the first remote terminal in a case where a Destination QP of the BTH of the second RDMA transmission packet matches a Destination QP of the BTH of the first RDMA transmission packet, and
discards the second RDMA transmission packet in a case where the Destination QP of the BTH of the second RDMA transmission packet does not match the Destination QP of the BTH of the first RDMA transmission packet.

6. A processing method comprising:
by a local terminal, transmitting, to a processing device, an RDMA transmission packet in which processing data to be transferred to a memory of an accelerator of each of a first remote terminal and a second remote terminal is set;
by the processing device, establishing a connection with the local terminal, and receiving the RDMA transmission packet from the local terminal;
by a first remote-side control unit of the processing device, establishing a connection with the first remote terminal;
by a second remote-side control unit of the processing device, establishing a connection with the second remote terminal;
by the processing device, inputting the RDMA transmission packet to the first remote-side control unit and the second remote-side control unit;
by the first remote-side control unit of the processing device, acquiring a QPN from the first remote terminal when a connection is established, converting a Destination QP of a base transport header (BTH) of the RDMA transmission packet into the QPN acquired from the first remote terminal, and transmitting a converted RDMA transmission packet to the first remote terminal;
by the second remote-side control unit of the processing device, acquiring a QPN from the second remote terminal when a connection is established, converting the Destination QP of the BTH of the RDMA transmission packet into the QPN acquired from the second remote terminal, and transmitting a converted RDMA transmission packet to the second remote terminal;
by the first remote terminal, receiving the converted RDMA transmission packet and transferring the processing data to the memory of the accelerator; and
by the second remote terminal, receiving the converted RDMA transmission packet and transferring the processing data to the memory of the accelerator.

7. A non-transitory computer readable medium storing one or more instructions causing a computer to function as the processing device according to claim 2.
